(19) United States
(12) Patent Application Publication
(10) Pub. No.: US 2022/0036196 A1
(43) Pub. Date: Feb. 3, 2022

(54) RECONFIGURABLE COMPUTING ARCHITECTURE FOR IMPLEMENTING ARTIFICIAL NEURAL NETWORKS

(71) Applicant: COMMISSARIAT A L'ENERGIE ATOMIQUE ET AUX ENERGIES ALTERNATIVES, PARIS (FR)

(72) Inventor: Michel HARRAND, GRENOBLE (FR)

(21) Appl. No.: 17/389,414

(22) Filed: Jul. 30, 2021

(30) Foreign Application Priority Data
Aug. 3, 2020 (FR) 2008236

(51) Int. Cl. G06N 3/08; G06N 3/063; G06F 7/544; G06F 7/523; G06F 7/50

(52) U.S. Cl. CPC G06N 3/084; G06N 3/063; G06F 7/50; G06F 7/523; G06F 7/5443

(57) ABSTRACT

A computer for computing a layer (Cₖ, Cₖ₊₁) of an artificial neural network is provided. The computer is able to be configured in accordance with two separate configurations and comprises: a transmission line; a set of computing units; a set of weight memories each associated with a computing unit, each weight memory containing a subset of synaptic coefficients required and sufficient for the associated computing unit to carry out the computations necessary for either one of the two configurations and control means for configuring the computing units of the computer in accordance with either one of the two configurations. In the first configuration, the computing units are configured such that a weighted sum is computed in full by one and the same computing unit. In the second configuration, the computing units are configured such that a weighted sum is computed by a chain of multiple computing units arranged in series.

### CROSS-REFERENCE TO RELATED APPLICATIONS

This application claims priority to foreign French patent application No. FR 2008236, filed on Aug. 3, 2020, the disclosure of which is incorporated by reference in its entirety.

### FIELD OF THE INVENTION

The invention relates in general to digital neuromorphic networks, and more particularly to a reconfigurable computer architecture for the computing of artificial neural networks based on convolutional or fully connected layers.

### BACKGROUND

Artificial neural networks are computational models imitating the operation of biological neural networks. Artificial neural networks comprise neurons that are interconnected by synapses, and each synapse is attached to a weight, implemented for example by digital memories. Artificial neural networks are used in various fields in which (visual, audio, inter alia) signals are processed, such as for example in the field of image classification or of image recognition.

Convolutional neural networks correspond to a particular model of artificial neural networks. Convolutional neural networks were first described in the article by K. Fukushima, “Neocognitron: A self-organizing neural network model for a mechanism of pattern recognition unaffected by shift in position. Biological Cybernetics, 36(4):193-202, 1980. ISSN 0340-1200. doi: 10.1007/BF00344251”.

Convolutional neural networks (as they are known, or “deep (convolutional) neural networks” or even “ConvNets”) are neural networks inspired by biological visual systems.

Convolutional neural networks (CNN) are used notably in image classification systems to improve classification. When applied to image recognition, these networks make it possible to learn intermediate representations of objects in images. Intermediate representations representing elementary features (in terms of shapes or contour for example) are smaller and able to be generalized for similar objects, thereby making them easier to recognize. However, the intrinsically parallel operation and the complexity of convolutional-neural-network classifiers makes them difficult to implement in embedded systems with limited resources. Specifically, embedded systems impose strict constraints in terms of the footprint of the circuit and in terms of electricity consumption.

The convolutional neural network is based on a sequence of layers of neurons, which may be convolutional layers, fully connected layers or layers carrying out other processing operations on data of an image. In the case of fully connected layers, a synapse connects each neuron of a layer to a neuron of the preceding layer. In the case of convolutional layers, only a subset of the neurons of a layer is connected to a subset of the neurons of another layer. Moreover, convolutional neural networks are able to process multiple input channels so as to generate multiple output channels. Each input channel corresponds for example to a different data matrix.

The input channels contain input images in matrix form, thus forming an input matrix; an output matrix image is obtained on the output channels.

The matrices of synaptic coefficients for a convolutional layer are also called “convolution kernels”.

In particular, convolutional neural networks comprise one or more convolutional layers, which are particularly expensive in terms of number of operations. The operations that are performed are mainly multiplication and accumulation (MAC) operations. Moreover, in order to comply with the latency and processing time constraints specific to the targeted applications, it is necessary to parallelize the computations as much as possible.

More particularly, when convolutional neural networks are embedded in a mobile system for telephony for example (as opposed to an implementation in data centre infrastructures), reducing electricity consumption becomes an essential criterion for implementing the neural network. In this type of implementation, the solutions from the prior art contain memories external to the computing units. This increases the number of read and write operations between separate electronic chips of the system. These data exchange operations between various chips are highly energy-consuming for a system dedicated to a mobile application (telephony, autonomous vehicle, robotics, etc.).

There is therefore a need for computers that are able to implement a convolutional layer of a neural network with limited complexity in order to satisfy the constraints of embedded systems and of the targeted applications. More particularly, there is a need to adapt the architectures of neural network computers so as to integrate memory blocks into the same chip containing the computing units (MAC). This solution limits the distances covered by the computing data and thus makes it possible to reduce the consumption of the entire neural network by limiting the number of read and write operations from and to said memories.

A neural network may propagate data from the input layer to the output layer, but also back-propagate error signals computed during a learning cycle from the output layer to the input layer. If the weights are put into a weight matrix so as to produce an inference (propagation), the order of the weights in this matrix is not suited to the computations carried out for a back-propagation phase.

More particularly, in neural network computing circuits according to the prior art, the synaptic coefficients (or weights) are stored in an external memory. During the execution of a computing step, buffer memories temporarily receive a certain number of the synaptic coefficients. These buffer memories are then refilled in each computing step with the weights to be used during a computing phase (inference or back-propagation) and in the order specific to the carrying out of this computing phase. These recurrent data exchanges considerably increase the consumption of the circuit. In addition, it is not feasible to double the number of memories (each suited to a computing phase) since this considerably increases the footprint of the circuit. The idea is to use internal memories containing the weights in a certain order while at the same time adapting the computer circuit in accordance with two configurations each suited to carrying out a computing phase (propagation or back-propagation).

### SUMMARY OF THE INVENTION

The invention proposes a computer architecture that makes it possible to reduce the electricity consumption of a neural network implemented on a chip, and to limit the number of read and write access operations between the computing units of the computer and the external memories. The invention proposes an artificial neural network accelerator computer architecture such that all of the memories containing the synaptic coefficients are implemented on the chip containing the computing units of the layers of neurons of the network. The architecture according to the invention exhibits configuration flexibility implemented via an arrangement of multiplexers for configuring the computer in accordance with two separate configurations. Combining this configuration flexibility and an appropriate distribution of the synaptic coefficients in the internal memories for the weights makes it possible to execute the many computing operations during an inference phase or a learning phase. The architecture proposed by the invention thus minimizes data exchanges between the computing units and the external memories or memories situated a relatively great distance away in the system-on-chip. This leads to an improvement in the energy efficiency of the neural network computer embedded in a mobile system. The accelerator computer architecture according to the invention is compatible with developing memory technologies such as NVM (non-volatile memory) requiring a limited number of write operations. The accelerator computer according to the invention is also compatible for executing operations of updating the weights. The accelerator computer according to the invention is compatible with inference and back-propagation computations (depending on the chosen configuration) for computing convolutional layers and fully connected layers in accordance with the specific distribution of the synaptic coefficients or the convolution kernels in the weight memories.

The invention relates to a computer for computing a layer of an artificial neural network. The neural network is formed of a sequence of layers each consisting of a set of neurons. Each layer is associated with a set of synaptic coefficients forming at least one weight matrix.

The computer is able to be configured in accordance with two separate configurations and comprises:

a transmission line for distributing input data;
a set of computing units of ranks n=0 to N, where N is an integer greater than or equal to 1, for computing an input data sum weighted by synaptic coefficients; a set of weight memories each associated with a computing unit, each weight memory containing a subset of synaptic coefficients required and sufficient for the associated computing unit to carry out the computations necessary for either one of the two configurations;
control means for configuring the computing units of the computer in accordance with either one of the two configurations; in the first configuration, the computing units are configured such that a weighted sum is computed in full by one and the same computing unit; in the second configuration, the computing units are configured such that a weighted sum is computed by a chain of multiple computing units arranged in series.

According to one particular aspect of the invention, the first configuration and the second configuration correspond, respectively, to operation of the computer in either one of the phases from among a data propagation phase and an error back-propagation phase.

According to one particular aspect of the invention, the input data are data propagated in the data propagation phase or errors back-propagated in the error back-propagation phase.

According to one particular aspect of the invention, the number of computing units is lower than the number of neurons in a layer.

According to one particular aspect of the invention, each computing unit comprises:

i. an input register for storing an input datum;
ii. a multiplier circuit for computing the product of an input datum and a synaptic coefficient;
iii. an adder circuit having a first input connected to the output of the multiplier circuit and being configured so as to carry out operations of summing partial computing results of a weighted sum;
iv. at least one accumulator for storing partial or final computing results of the weighted sum.

According to one particular aspect of the invention, the computer furthermore comprises: a data distribution element having N+1 outputs, each output being connected to the register of a computing unit of rank n. The distribution element is commanded by the control means so as to simultaneously distribute an input datum to all of the computing units when the first configuration is activated.

According to one particular aspect of the invention, the computer furthermore comprises a memory stage operating in accordance with a “first in first out” principle so as to propagate a partial result from the last computing unit of rank n=N to the first computing unit of rank n=0, the memory stage being activated by the control means when the second configuration is activated.

According to one particular aspect of the invention, each computing unit comprises at least a number of accumulators equal to the number of neurons per layer divided by the number of computing units rounded up to the nearest integer.

According to one particular aspect of the invention, each set of accumulators comprises a write input able to be selected from among the inputs of each accumulator of the set and a read output able to be selected from among the outputs of each accumulator of the set.

Each computing unit of rank n=1 to N comprises: a multiplexer having a first input connected to the output of the set of accumulators of the computing unit of rank n, a second input connected to the output of the set of accumulators of a computing unit of rank n−1 and an output connected to a second input of the adder circuit of the computing unit of rank n.

The computing unit of rank n=0 comprises: a multiplexer having a first input connected to the output of the set of accumulators of the computing unit of rank n=0, a second input connected to the output of the set of accumulators of the computing unit of rank n=0 and an output connected to a second input of the adder circuit of the computing unit of rank n=0.

The control means are configured so as to select the first input of each multiplexer when the first configuration is chosen and to select the second input of each multiplexer when the second configuration is activated.

According to one particular aspect of the invention, all of the sets of accumulators are interconnected so as to form a memory stage for propagating a partial result from the last computing unit of rank n=N to the first computing unit of rank n=0, the memory stage operating in accordance with a “first in first out” principle when the second configuration is activated.

According to one particular aspect of the invention, the computer comprises a set of error memories, such that each one is associated with a computing unit, for storing a subset of computed errors.

According to one particular aspect of the invention, for each computing unit, the multiplier is connected to the error memory associated with the same computing unit so as to compute the product of an input datum and a stored error signal during a phase of updating the weights.

According to one particular aspect of the invention, the computer comprises a read circuit connected to each weight memory for commanding the reading of the synaptic coefficients.

According to one particular aspect of the invention, in the computer, a computed layer is fully connected to the preceding layer, and the associated synaptic coefficients form a weight matrix of size M×M′, where M and M′ are the respective numbers of neurons in the two layers.

According to one particular aspect of the invention, the distribution element is commanded by the control means so as to distribute an input datum associated with a neuron of rank i to a computing unit of rank n, such that i modulo N+1 is equal to n when the second configuration is activated.

According to one particular aspect of the invention, when the first configuration is activated, all of the multiplication and addition operations for computing the weighted sum associated with the neuron of rank i are carried out exclusively by the computing unit of rank n, such that i modulo N+1 is equal to n.

According to one particular aspect of the invention, when the second configuration is activated, each computing unit of rank n=1 to N carries out the operation of multiplying each input datum associated with the neuron of rank j by a synaptic coefficient, such that j modulo N+1 is equal to n, followed by addition of the output from the computing unit of rank n-1, so as to obtain a partial or total result of a weighted sum.

According to one particular aspect of the invention, the subset of synaptic coefficients stored in the weight memory of rank n corresponds to the synaptic coefficients of all of the rows of rank i of the weight matrix, such that i modulo N+1 is equal to n, when the first configuration is a computing configuration for the data propagation phase and the second configuration is a computing configuration for the error back-propagation phase.

According to one particular aspect of the invention, the subset of synaptic coefficients stored in the weight memory of rank n corresponds to the synaptic coefficients of all of the columns of rank j of the weight matrix, such that j modulo N+1 is equal to n, when the first configuration is a computing configuration for the error back-propagation phase and the second configuration is a computing configuration for the data propagation phase.

According to one particular aspect of the invention, the neural network comprises at least one convolutional layer of neurons, the layer having a plurality of output matrices of rank q=0 to Q, where Q is a positive integer, each output matrix being obtained from at least one input matrix of rank p=0 to P, where P is a positive integer, for each input matrix of rank p and output matrix of rank q pair, the associated synaptic coefficients forming a weight matrix.

According to one particular aspect of the invention, when the first configuration is activated, all of the multiplication and addition operations for computing an output matrix of rank q are carried out exclusively by the computing unit of rank n, such that q modulo N+1 is equal to n.

According to one particular aspect of the invention, when the second configuration is activated, each computing unit of rank n=1 to N carries out the operations of computing the partial results obtained from each input matrix of rank p, such that p modulo N+1 is equal to n, followed by addition of the partial result from the computing unit of rank n-1.

According to one particular aspect of the invention, the subset of synaptic coefficients stored in the weight memory of rank n corresponds to the synaptic coefficients belonging to all of the weight matrices associated with the output matrix of rank q, such that q modulo N+1 is equal to n, when the first configuration is a computing configuration for the data propagation phase and the second configuration is a computing configuration for the error back-propagation phase.

According to one particular aspect of the invention, the subset of synaptic coefficients stored in the weight memory of rank n corresponds to the synaptic coefficients belonging to all of the weight matrices associated with the input matrix of rank p, such that p modulo N+1 is equal to n, when the first configuration is a computing configuration for the error back-propagation phase and the second configuration is a computing configuration for the data propagation phase.

### BRIEF DESCRIPTION OF THE DRAWINGS

Other features and advantages of the present invention will become more clearly apparent upon reading the following description with reference to the following appended drawings.

FIG. 1 shows one example of a convolutional neural network containing convolutional layers and fully connected layers.

FIG. 2 uses one example of a pair of fully connected layers of neurons belonging to a convolutional neural network to illustrate the operation of the network during an inference phase.

FIG. 3 uses one example of a pair of fully connected layers of neurons belonging to a convolutional neural network to illustrate the operation of the network during a back-propagation phase.

FIG. 4 illustrates a functional diagram of an accelerator computer able to be configured so as to compute a layer of artificial neurons in propagation mode and in back-propagation mode, according to one embodiment of the invention.

FIG. 5 illustrates the weight matrix associated with the layer of neurons fully connected to the preceding layer via synaptic coefficients distributed among the weight memories, according to one embodiment of the invention.

FIG. 6a illustrates a functional diagram of the accelerator computer according to FIG. 4, configured in accordance with the first configuration so as to compute a layer of artificial neurons in a propagation phase.

FIG. 6b illustrates one example of computing sequences carried out by the computer according to the invention configured in accordance with the first configuration in a propagation phase as shown in FIG. 6a.

FIG. 7a illustrates a functional diagram of the accelerator computer configured in accordance with the second configuration so as to compute a layer of artificial neurons in a back-propagation phase.

FIG. 7b illustrates one example of computing sequences carried out by the computer according to the invention configured in accordance with the second configuration in a back-propagation phase as shown in FIG. 7a.

FIG. 7c illustrates one example of the operation of the set of accumulators in accordance with the “first in first out” principle in the computer according to FIGS. 7b and 7a.

FIG. 8 illustrates a functional diagram of the accelerator computer according to the invention configured so as to update the weights during a learning phase.

FIG. 9a shows a first illustration of the operation of a convolutional layer of a convolutional neural network with one input channel and one output channel.

FIG. 9b shows a second illustration of the operation of a convolutional layer of a convolutional neural network with one input channel and one output channel.

FIG. 9c shows a third illustration of the operation of a convolutional layer of a convolutional neural network with one input channel and one output channel.

FIG. 9d shows an illustration of the operation of a convolutional layer of a convolutional neural network with multiple input channels and multiple output channels.

### DETAILED DESCRIPTION

By way of indication, we will begin by describing one example of the overall structure of a convolutional neural network containing convolutional layers and fully connected layers.

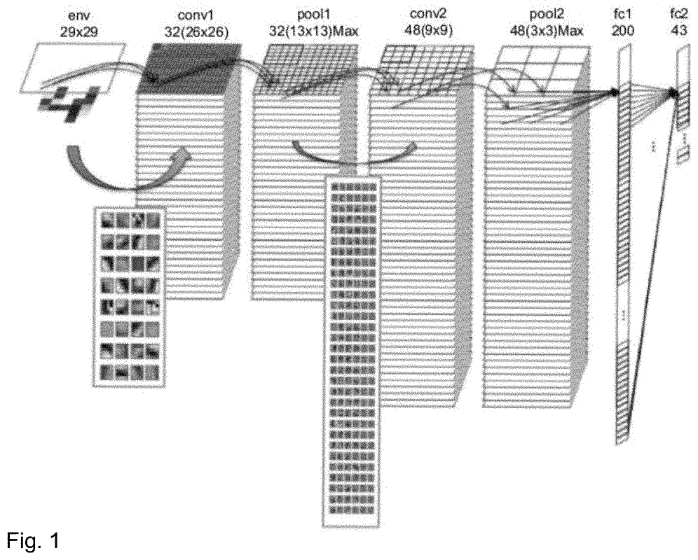

FIG. 1 shows the overall architecture of one example of a convolutional network for image classification. The images at the bottom of FIG. 1 show an extract of the convolution kernels of the first layer. An artificial neural network (also called a “formal” neural network or referred to simply by the expression “neural network” below) consists of one or more layers of neurons, which are interconnected to one another.

Each layer consists of a set of neurons, which are connected to one or more preceding layers. Each neuron of a layer may be connected to one or more neurons of one or more preceding layers. The last layer of the network is called the “output layer”. The neurons are connected to one another by synapses associated with synaptic weights, which weight the efficiency of the connection between the neurons, form the adjustable parameters of a network and which store the information contained in the network. The synaptic weights may be positive or negative.

The input data of the neural network correspond to the input data of the first layer of the network. Running through the sequence of layers of neurons, the output data computed by an intermediate layer correspond to the input data of the following layer. The output data from the last layer of neurons correspond to the output data from the neural network.

The neural networks referred to as “convolutional” networks (or even “deep convolutional” networks or “convnets”) furthermore consist of layers of particular types, such as convolutional layers, pooling layers and fully connected layers. By definition, a convolutional neural network comprises at least one convolutional layer or “pooling” layer.

The architecture of the accelerator computer circuit according to the invention is compatible for executing computations of convolutional layers or fully connected layers. We will first of all start by describing the appropriate embodiment with the computation of a fully connected layer.

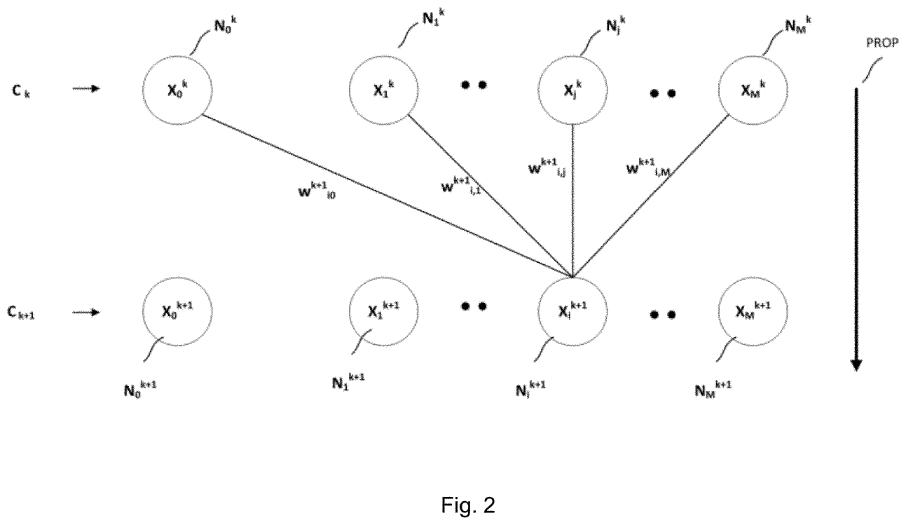

FIG. 2 illustrates a diagram of a pair of fully connected layers of neurons belonging to a convolutional neural network during an inference phase. FIG. 2 is used to understand the basic mechanisms of the computations in this type of layer during an inference phase in which the data are propagated from the neurons of the layer Cₖ of rank k to the neurons of the following layer Cₖ₊₁ of rank k+1.

The layer of neurons Cₖ of rank k comprises M+1 neurons of rank j=0 to M, where M is a positive integer greater than or equal to 1. The neuron Nⱼ^{k} of rank j belonging to the layer of rank k produces a value denoted Xⱼ^{k} at output.

The layer of neurons Cₖ₊₁ of rank k+1 comprises M′+1 neurons of rank i=0 to M′, where M′ is a positive integer greater than or equal to 1. The neuron Nik+1 of rank i belonging to the layer of rank k+1 produces a value denoted Xik+1 at output. In the example of FIG. 2, the two successive layers Cₖ and Cₖ₊₁ are of the same size M+1.

Since the layer Cₖ₊₁ is fully connected, each neuron Nᵢ^{k+1} belonging to this layer is connected to each of the neurons Nᵢ^{k} by an artificial synapse. The synaptic coefficient that connects the neuron Nᵢ^{k+1} of rank i of the layer Cₖ₊₁ to the neuron Nⱼ^{k} of rank j of the layer Cₖ is the scalar wᵢⱼ^{k+1}. The set of synaptic coefficients linking the layer Cₖ₊₁ to the layer Cₖ thus form a weight matrix of size (M′+1)×(M+1), denoted [MP]^{k+1}. In FIG. 2, the size of the two consecutive layers is the same, and the weight matrix [MP]^{k} is then a squared matrix of size (M+1)×(M+1).

Let [Lᵢ]^{k+1} be the row vector of index i of the weight matrix [MP]^{k+1}. [Lᵢ]^{k+1} consists of the following synaptic coefficients:

[Lᵢ]^{k+1}=(wᵢ₀^{k+1},wᵢ₁^{k+1},wᵢ₂^{k+1},wᵢ₃^{k+1} . . . ,w_{i(M-2)}^{k+1},w_{i(M-1)}^{k+1},w_{iM}^{k+1}).

The set of synaptic coefficients that form the row vector [Lᵢ]^{k}+1 of the weight matrix [MP]^{k+1} correspond to all of the synapses connected to the neuron Nᵢ^{k+1} of rank i of the layer Cₖ₊₁, as shown in FIG. 2.

Following the propagation direction “PROP” indicated in FIG. 2, in an inference phase, the datum Xᵢ^{k+1} associated with the neuron Nᵢ^{k+1} of the layer Cₖ₊₁ is computed using the following formula: Xᵢ^{(k+1)}=S(Σⱼ(Xⱼ^{k}·wᵢⱼ^{k+1})+bᵢ), where bᵢ is a coefficient called “bias” and S(x) is a non-linear function, such as a ReLu function for example. The ReLu function is applied by a microcontroller or a dedicated operator circuit different from the accelerator computer that is the subject of the invention, the main role of which is that of computing the weighted sum Σⱼ(Xⱼ^{k}·Wᵢⱼ^{k+1}).

Developing the formula of the weighted sum used in the computation of Xᵢ^{(k+1)} during propagation of the data from the layer Cₖ to the layer Cₖ₊₁ gives the following sum:

Xᵢ^{(k+1)}=S(X₀^{k}·wᵢ₀^{k+1}+X₁^{k}·wᵢ₁^{k+1}+X₂^{k}·wᵢ₂^{k+1}+ . . . +X_{(M-1)}^{k}·w_{i(M-1)}^{k+1}+X_{M}^{k}·w_{iM}^{k+1}+bᵢ)

This then demonstrates that the subset denoted Fᵢ of the synaptic coefficients used to compute the weighted sum Σⱼ(Xⱼ^{k}·wᵢⱼ^{k+1}) in order to obtain the output datum Xᵢ^{(k+1)} from the neuron Nᵢ^{k+1} is [Lᵢ]^{k+1} the row vector of index i of the weight matrix [MP]^{k+1}.

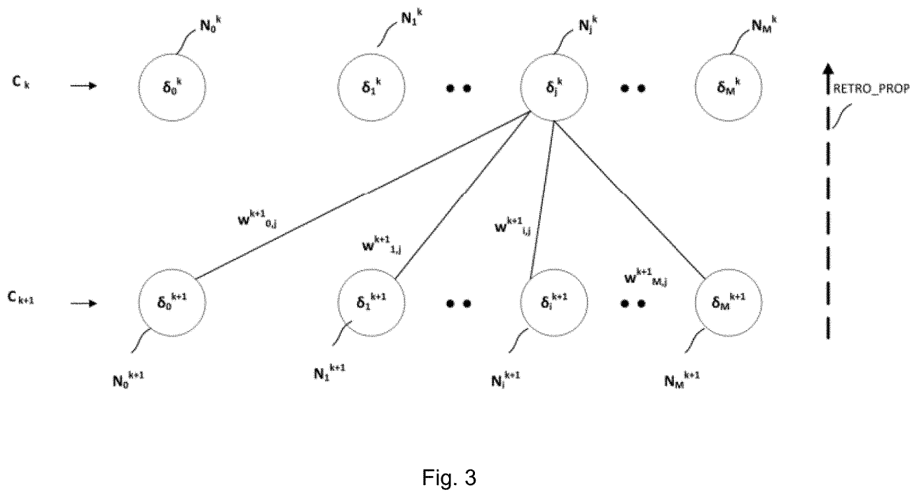

In preparation for the description of FIG. 3, we will first of all explain the sequence of the learning phase of a convolutional neural network, which takes place in accordance with the following steps:

A first propagation step for learning consists in processing a set of input images in exactly the same way as in inference mode (but in floating point mode). Unlike inference, it is necessary to store all of the values of Xᵢ^{(k)} (therefore of all of the layers) for all of the images.

When the last output layer is computed, the second step of computing a cost function is triggered. The result of the preceding step in the last layer of the network is compared, by way of a cost function, with labelled references. The derivative of the cost function is computed so as to obtain an error δᵢ^{k} for each neuron Nᵢ^{K} of the final output layer C_{K}. The computing operations in this step (cost function+differentiation) are carried out by an embedded microcontroller different from the computer that is the subject of the invention.

The following step consists in back-propagating the errors computed in the preceding step through the layers of the neural network starting from the output layer of rank K. More detail about this back-propagation phase will be given in the description of FIG. 3.

The final step corresponds to updating the synaptic coefficients wᵢⱼ^{k} of the entire neural network based on the results of the preceding computations for each neuron of each layer.

FIG. 3 illustrates a diagram of the same pair of fully connected layers of neurons described in FIG. 2, but during a back-propagation phase. FIG. 3 is used to understand the basic mechanisms of the computations in this type of layer during an error back-propagation phase in the learning phase. The data correspond to computed errors, generally denoted δᵢ, which are back-propagated from the neurons of the layer Cₖ₊₁ of rank k+1 to the neurons of the following layer Cₖ of rank k.

The direction of the back-propagation is illustrated in FIG. 3.

FIG. 3 illustrates the same pair of layers of neurons Cₖ and Cₖ₊₁ as that illustrated in FIG. 2. The set of synaptic coefficients linking the layer Cₖ₊₁ to the layer Cₖ still form the weight matrix of size (M+1)x(M+1), denoted [MP]^{k+1}. The difference with respect to FIG. 2 lies in the nature of the input and output data for the computation, which correspond to errors δᵢ^{k+1} and the opposite propagation direction.

Starting from the back-propagation direction “RETRO_PROP”, in a learning phase, the error δⱼ^{k} associated with the neuron Nⱼ^{k} of the layer Cₖ is computed using the following formula: δⱼ^{k}=Σᵢ(δᵢ^{k+1}·wᵢⱼ^{k+1})·∂S(x)/∂x, where ∂S(x)/∂x is the derivative of the activation function, which is equal to 0 or 1 if using a ReLu function. More generally, the multiplication by the derivative of the activation function is carried out by a dedicated operator circuit different from the accelerator computer that is the subject of the invention, the main role of which is that of computing the weighted sum Σᵢ(δᵢ^{k+1}·wᵢⱼ^{k+1}).

Developing the formula of the weighted sum used in the computation of δⱼ^{k} during back-propagation of the errors from the layer Cₖ₊₁ to the layer Cₖ gives the following sum:

δⱼ^{k}=δ₀^{k+1}·w₀ⱼ^{k+1}+δ₁^{k+1}·w₁ⱼ^{k+1}+δ₂^{k+1}·w₂ⱼ^{k+1}+ . . . +δ_{M-1}^{k+1}·w_{(M-1)j}^{k+1}+δ_{M}^{k+1}·w_{Mj}^{k+1}

This then demonstrates that the subset of the synaptic coefficients used to compute the weighted sum Σᵢ(δᵢ^{k+1}·wᵢⱼ^{k+1}) of the neuron Nⱼ^{k} corresponds to [Cⱼ]^{k+1} the column vector of the weight matrix [MP]^{k+1} of index j of the weight matrix [MP]^{k+1}, where [Cⱼ]^{k+1}=(w₀ⱼ^{k+1}, w₁ⱼ^{k+1}, w₂ⱼ^{k+1}, w₃ⱼ^{k+1} . . . , w_{(M-2)j}^{k+1}, w_{(M-1)j}^{k+1}, w_{Mj}^{k+1}).

In FIG. 3, it is possible to verify that the set of synapses that connects the neuron Nⱼ^{k} of the layer Cₖ corresponds to the synaptic coefficients of the column [Cⱼ]^{k+1}.

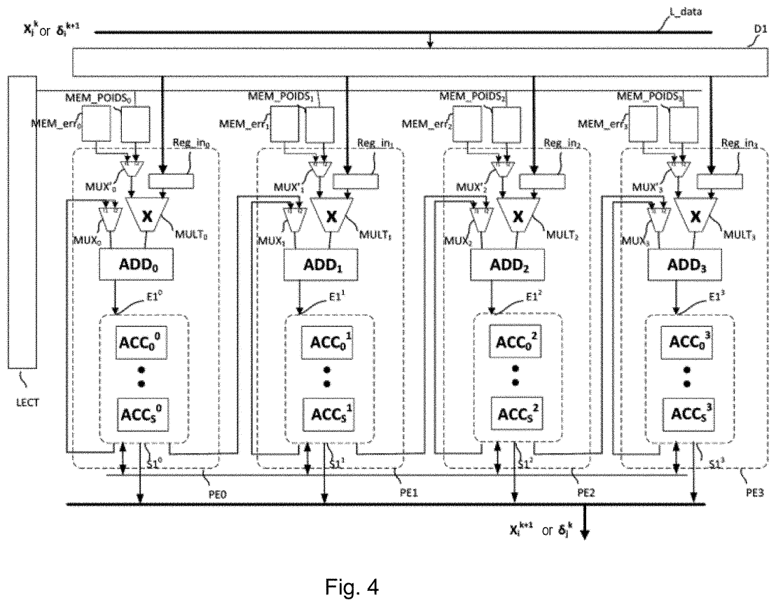

FIG. 4 illustrates a functional diagram of an accelerator computer able to be configured so as to compute a layer of artificial neurons in propagation mode and in back-propagation mode, according to one embodiment of the invention.

One objective of the neural layer computer CALC according to the invention consists in using the same memories to store the synaptic coefficients in accordance with a distribution appropriately chosen to execute both the data propagation phase and the error back-propagation phase. The computer is able to be configured in accordance with two separate configurations, respectively denoted CONF1 and CONF2, implemented via a specific arrangement of multiplexers that is described below. The computer thus makes it possible to compute weighted sums during a data propagation phase or an error back-propagation phase depending on the chosen configuration.

The computer CALC according to the invention comprises a transmission line denoted L_data for distributing input data Xⱼ^{k} or error data δᵢ^{k+1} in accordance with the execution of a propagation phase or back-propagation phase; a set of computing units denoted PEₙ of ranks n=0 to N, where N is a positive integer greater than or equal to 1, for computing a sum of input data weighted by synaptic coefficients; a set of weight memories denoted MEM_POIDSₙ, such that each weight memory is connected to a computing unit; control means for configuring the operation and the internal or external connections of the computing units in accordance with the first configuration CONF1 or the second configuration CONF2.

The computer CALC furthermore comprises a read stage denoted LECT connected to each weight memory MEM_POIDSₙ for commanding the reading of the synaptic coefficients w_{i,j}^{k} during the execution of the operations of computing the weighted sums.

The computer CALC furthermore comprises a set of error memories denoted MEM_errₙ of ranks n=0 to N, where N+1 is the number of computing units PEₙ in the computer CALC. Each error memory is associated with a computing unit for storing a subset of computed errors δⱼ^{k} that are used during the phase of updating the weights.

To understand the operation of the accelerator computer CALC according to the invention for each computing phase, specifically the propagation or the back-propagation, FIG. 4 also illustrates the sub-blocks forming a computing unit PEₙ. By way of indication, and to simplify the explanation of the invention, we will limit ourselves to one example of the computer containing four computing units, respectively denoted PE₀, PE₁, PE₂, PE₃. This then involves using four weight memories respectively denoted MEM_POIDS₀, MEM_POIDS₁, MEM_POIDS₂, MEM_POIDS₃ and four error memories respectively denoted MEM_err₀, MEM_err₁, MEM_err₂, MEM_err₃.

Each computing unit PEₙ of rank n=0 to 3 comprises an input register denoted Reg_inₙ for storing an input datum used in the computing of the weighted sum, be this a propagated datum Xᵢ^{(k)} or a back-propagated error δᵢ^{k+1} depending on the executed phase; a multiplier circuit denoted MULTₙ having two inputs and one output, an adder circuit denoted ADDₙ having a first input connected to the output of the multiplier circuit MULTₙ and being configured so as to carry out operations of summing partial computing results of a weighted sum; at least one accumulator denoted ACCᵢⁿ for storing partial or final computing results of the weighted sum computed by the computing unit PEₙ of rank n or another computing unit of a different rank, depending on the selected configuration.

The input data from the transmission line L_data are distributed to the various computing units PEₙ by controlling the activation of the loading of the input registers Reg_inₙ. Activation of the loading of an input register Reg_inₙ is commanded by the control means of the system. If the loading of a register Reg_inₙ is not activated, the register keeps the stored datum from the preceding computing cycle. If the loading of a register Reg_inₙ is activated, it stores the datum transmitted by the transmission line L_data during the current computing cycle.

As an alternative, the computer CALC furthermore comprises a distribution element denoted D1 commanded by the control means so as to organize the distribution of the input data from the transmission line L_data to the computing units PEₙ in accordance with the chosen computing configuration.

In the described embodiment, when the number of neurons per layer is greater than the number of computing units PEₙ in the computer CALC, each computing unit PEₙ comprises a plurality of accumulators ACCᵢⁿ. The set of accumulators belonging to the same computing unit comprises a write input denoted E1ⁿ able to be selected from among the inputs of each accumulator of the set and a read output denoted S1ⁿ able to be selected from among the outputs of each accumulator of the set. It is possible to implement this write input and read output selection functionality for a stack of accumulator registers through commands to activate the loading of the registers in write mode and multiplexers for the outputs, not shown in FIG. 4.

Each computing unit PEₙ of rank n=0 to 3 furthermore comprises a multiplexer MUXₙ having two inputs denoted I1 and I2 and one output connected to the second input of the adder ADDₙ belonging to the computing unit PEₙ.

For the computing units PEₙ of rank n=1 to 3, the first input I1 of a multiplexer MUXₙ is connected to the output S1ⁿ of the set of accumulators {ACC₀ⁿ ACC₁ⁿ ACC₂ⁿ . . . } belonging to the computing unit of rank n, and the second input I2 is connected to the output S1ⁿ⁻¹ of the set of accumulators {ACC₀ⁿ⁻¹ ACC₁ⁿ⁻¹ ACC₂ⁿ⁻¹ . . . } of the computing unit of rank n−1. The output of the multiplexer MUXₙ is connected to the second input of the adder circuit ADDₙ belonging to the same computing unit PEₙ of rank n.

For the initial computing unit PE₀ of rank 0, the two inputs of the multiplexer MUX₀ are connected to the output S1⁰ of the set of accumulators {ACC₀⁰ ACC₁⁰ ACC₂⁰} of the initial computing unit of rank 0. It is possible to dispense with this multiplexer, but it has been retained in this embodiment so as to obtain symmetrical computing units.

Each computing unit PEₙ of rank n=0 to 3 furthermore comprises a second multiplexer MUX′ₙ having two inputs and one output connected to the second input of the multiplier circuit MULTₙ belonging to the same computing unit PEₙ. The first input of the multiplexer MUX′ₙ is connected to the error memory MEM_errₙ of rank n and the second input is connected to the weight memory MEM_POIDSₙ of rank n. The multiplexer MUX′ₙ thus makes it possible to select whether the multiplier MULTₙ computes the product of the input datum stored in the register Reg_inₙ and a synaptic coefficient wᵢⱼ^{k} from the weight memory MEM_POIDSₙ (during a propagation or back-propagation) or an error value δⱼ^{k} stored in the error memory MEM_errₙ (during the updating of the weights).

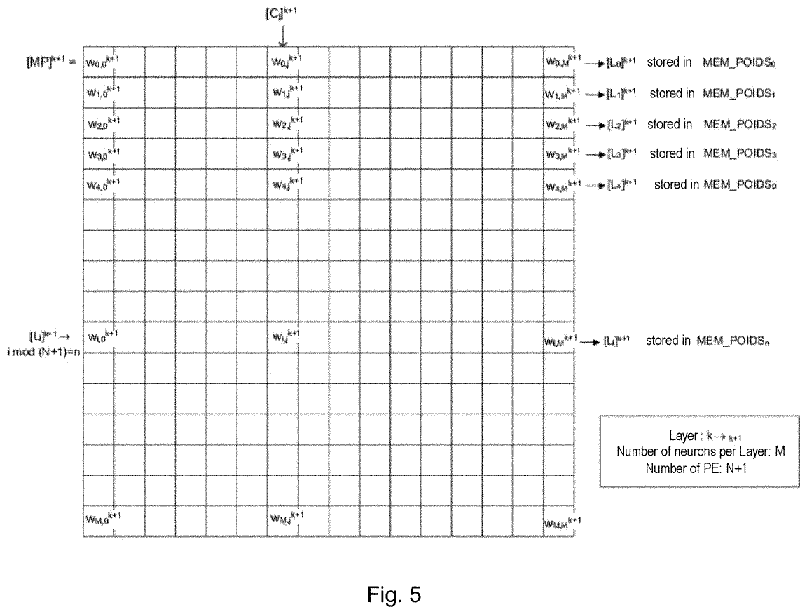

FIG. 5 illustrates the weight matrix [MP]^{k+1} associated with the layer of neurons Cₖ₊₁ fully connected to the preceding layer Cₖ via synaptic coefficients wᵢⱼ^{k+1.}

As demonstrated above, the subset of the synaptic coefficients necessary and sufficient to compute the weighted sum (Σⱼ(Xⱼ^{k}·wᵢⱼ^{k+1}) in order to obtain the output datum Xᵢ^{(k+1)} from the neuron Nᵢ^{k+1} during a propagation phase corresponds to [Lᵢ]^{k+1} the row vector of index i of the weight matrix [MP]^{k+1.}

In order to solve the problem linked to minimizing the energy consumption of the neural network, the synaptic coefficients should be expediently distributed among the set of weight memories MEM_POIDSₙ so as to comply with the following criteria: the possibility of integrating the weight memories into the same chip of the computer; minimizing the number of write operations to the weight memories and minimizing the distances covered by the data during an exchange between a computing unit and a weight memory.

During a data propagation phase, the computing unit of rank n PEₙ carries out all of the multiplication and addition operations so as to compute the weighted sum Σⱼ(Xⱼ^{k}·wᵢⱼ^{k+1}) in order to obtain the output datum Xᵢ^{(k+1)} from the neuron Nᵢ^{k+1}; the weight memory MEM_POIDSₙ of rank n associated with the computing unit PEₙ of rank n should contain the synaptic coefficients that form the row vector [Lᵢ]^{k+1} of the matrix [MP]^{k+1}.

If the layer of neurons contains a number of neurons greater than the number of computing units, the computations are organized as follows: The computing unit of rank n PEₙ carries out all of the multiplication and addition operations so as to compute the weighted sum of each of the neurons of rank i Nᵢ^{k+1}, such that i modulo (N+1) is equal to n.

By way of example, if the layer Cₖ₊₁ contains sixteen neurons and the computer CALC comprises N=4 computing units {PE₀, PE₁, PE₂, PE₃}:

The computing unit PE₀ computes the output data Xᵢ^{(k+1)} from the neurons N₀^{k+1}, N₄^{k+1}, N₈^{k+1}, N₁₂^{k+1}.

In parallel, the computing unit PE₁ computes the output data Xᵢ^{(k+1)} from the neurons N₁^{k+1}, N₅^{k+1}, N₉^{k+1}, N₁₃^{k+1}.

In parallel, the computing unit PE₂ computes the output data Xᵢ^{(k+1)} from the neurons N₂^{k+1}, N₆^{k+1}, N₁₀^{k+1}, N₁₄^{k+1}.

In parallel, the computing unit PE₁ computes the output data Xᵢ^{(k+1)} from the neurons N₁^{k+1}, N₇^{k+1}, N₁₁^{k+1}, N₁₅^{k+1}.

To achieve the computing parallelism described above during a propagation phase (computing performance criterion), while at the same time complying with the abovementioned criteria linked to the memories (consumption criterion and implementation criterion), the synaptic coefficients wᵢⱼ^{k+1} are distributed among the weight memories such that each weight memory of rank n MEM_POIDSₙ contains exclusively the row vectors [Lᵢ]^{k+1} of the matrices [MP]^{k+1} for all of the fully connected layers, such that i modulo (N+1)=n.

We will keep this distribution to explain the sequence of the computations executed by the computer according to the invention with the following figures:

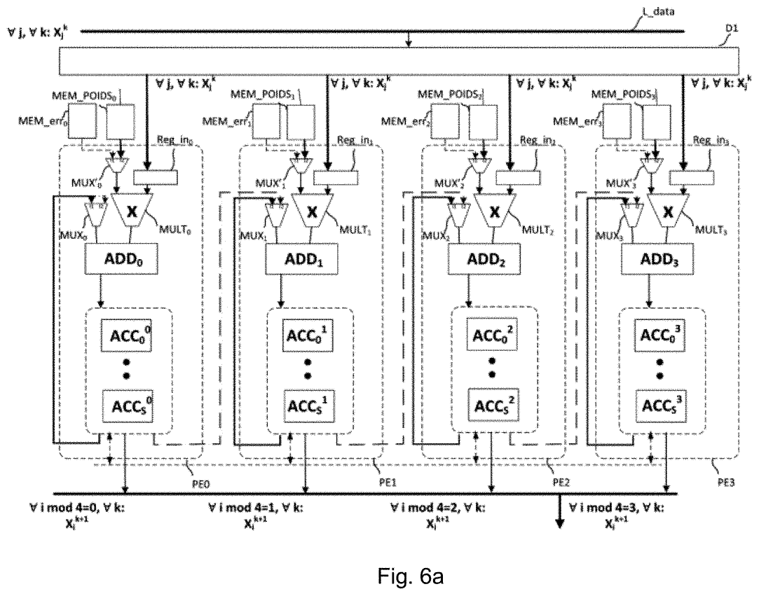

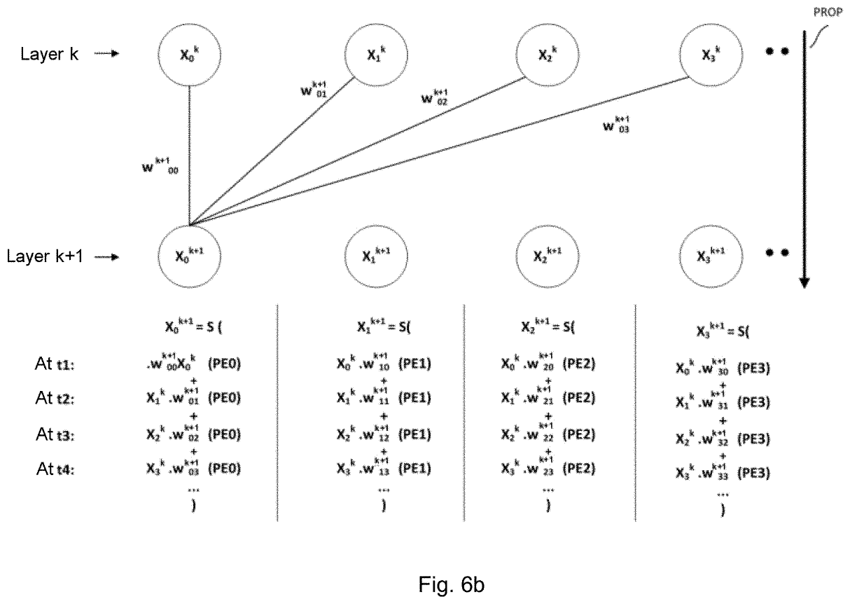

FIG. 6a illustrates a functional diagram of the accelerator computer CALC configured in accordance with the first configuration CONF1 so as to compute a layer of artificial neurons in a propagation phase.

In a data propagation phase, each multiplexer MUX′ₙ of rank n is configured, by the control means, so as to select the input connected to the associated weight memory.

When the first configuration CONF1 is chosen, the control means configure each multiplexer MUXₙ belonging to the computing unit PEₙ so as to select the input 11 connected to the set of accumulators {ACC₀ⁿ ACC₁ⁿ ACC₂ⁿ . . . } of the same computing unit. The computing units PEₙ are thus disconnected from one another when the configuration CONF1 is chosen.

FIG. 6b illustrates one example of computing sequences carried out by the computer configured in accordance with the first configuration in a propagation phase as shown in FIG. 6a.

It will be recalled that each weight memory of rank n contains the subset of synaptic coefficients corresponding to the row vector [Lᵢ]^{k+1} of rank i of the matrix [MP]^{k+1} associated with the layer of neurons Cₖ₊₁, such that i modulo (N+1)=n.

When the computer is configured in accordance with the first configuration CONF1, the control means command the loading of the registers Reg_inₙ (or the distribution element D1 in an alternative embodiment) so as to simultaneously supply the same input datum Xᵢ^{k} from the preceding layer Cₖ to all of the computing units PEₙ.

At a time t1, the computing unit PE₀ computes the product w₀₀^{k+1}·X₀^{k} corresponding to the first term of the weighted sum Σⱼ(Xⱼ^{k}·w₀ⱼ^{k+1}) corresponding to the output datum from the neuron N₀^{k+1}; the computing unit PE₁ computes the product w₁₀^{k+1}·X₀^{k} corresponding to the first term of the weighted sum Σⱼ(Xⱼ^{k}·w₁ⱼ^{k+1}) corresponding to the output datum from the neuron N₁^{k+1}; the computing unit PE₂ computes the product w₂₀^{k+1}·X₀^{k} corresponding to the first term of the weighted sum Σⱼ(Xⱼ^{k}·w₂ⱼ^{k+1}) corresponding to the output datum from the neuron N₂^{k+1}; the computing unit PE₃ computes the product w₃₀^{k+1}·X₀^{k} corresponding to the first term of the weighted sum Σⱼ(Xⱼ^{k}·w₃ⱼ^{k+1}) corresponding to the output datum from the neuron N₃^{k+1}. Each computing unit PEₙ stores the obtained first term of the weighted sum in an accumulator ACC₀ⁿ of the set of accumulators associated with the same computing unit. At t2, the computing unit PE₀ computes the product w₀₁^{k+1}·X₁^{k} corresponding to the second term of the weighted sum Σⱼ(Xⱼ^{k}·w₀ⱼ^{k+1}) corresponding to the output datum from the neuron N₀^{k+1} and the adder ADD₀ sums the first term w₀₀^{k+1}·X₀^{k} stored in the accumulator ACC₀⁰ and the second term w₀₁^{k+1}·X₁^{k} via the loopback internal to the computing unit in accordance with the configuration CONF1; the computing unit PE₁ computes the product w₁₁^{k+1}·X₁^{k} corresponding to the second term of the weighted sum Σⱼ(Xⱼ^{k}·w₁ⱼ^{k+1}) corresponding to the output datum from the neuron N₁^{k+1} and the adder ADD₁ sums the first term w₁₀^{k+1}·X₀^{k} stored in the accumulator ACC₀¹ and the second term w₁₁^{k+1}·X₁^{k} via the loopback internal to the computing unit in accordance with the configuration CONF1. The same computing process is executed by the computing units PE₂ and PE₃ to compute and store the partial results of the neurons N₂^{k+1} and N₃^{k+1}.

If the weighted sum contains M terms (computed from M neurons of the layer Cₖ), the operation described above is reiterated M times until obtaining final results Xᵢ^{k+1} of the four first neurons of the output layer Cₖ₊₁, specifically {N₀^{k+1}, N₁^{k+1}, N₂^{k+1}, N₃^{k+1}}. In the cycle t_{M+1}, the computing unit PE₀ begins a new series of iterations in order to compute the terms of the weighted sum X₄^{k+1} of the neuron N₄^{k+1}; the computing unit PE₁ begins a new series of iterations in order to compute the terms of the weighted sum X₅^{k+1} of the neuron N₅^{k+1}, the computing unit PE₂ begins a new series of iterations in order to compute the terms of the weighted sum X₆^{k+1} of the neuron N₆^{k+1}, and the computing unit PE₃ begins a new series of iterations in order to compute the terms of the weighted sum X₇^{k+1} of the neuron N₇^{k+1}. Thus, after M cycles, the computer CALC has computed the neurons {N₄^{k+1}, N₅^{k+1}, N₆^{k+1}, N₇^{k+1}}.

The operation is reiterated until obtaining all of the Xᵢ^{k+1} from the output layer Cₖ₊₁. This computing method carried out by the computer does not require any write operation to the weight memories MEM_POIDSₙ since the distribution of the synaptic coefficients w_{i,j}^{k+1} allows each computing unit to carry out all of the multiplication operations necessary and sufficient to compute the subset of the output neurons associated therewith.

Below, we will present a second computing method compatible with the computer CALC and for minimizing the number of write operations to the input registers Reg_inₙ.

As an alternative, another method for computing the fully connected layer Cₖ₊₁ may be executed by the computer CALC while at the same time avoiding loading an input datum Xᵢ^{k} to the input registers Reg_inₙ multiple times.

To carry out the alternative computing method, the computer CALC operates as follows: At t1, the same computations are carried out by each computing unit PEₙ so as to obtain the first terms of the weighted sum of each of the neurons {N₀^{k+1}, N₁^{k+1}, N₂^{k+1}, N₃^{k+1}} that are stored in one of the associated accumulators. At t2, in contrast to the preceding computing method, the computing unit PE₀ of rank n=0 does not compute the second term of the weighted sum of the output neurons N₀^{k+1}, but computes the first term of the weighted sum of the output neuron N₄^{k+1} and stores the result in another accumulator ACC₁⁰ of the same computing unit. Next, at t3, the computing unit PE₀ computes the first term of the output neuron N₈^{k+1} and records the result in the following accumulator ACC₂⁰. The operation is reiterated until the computing unit PE₀ obtains all of the first terms of each weighted sum of all of the output neurons Nᵢ^{k+1}, such that i modulo (N+1)=0.

In parallel, each computing unit PEₙ of rank n computes and records the first partial results of all of the output neurons Nᵢ^{k+1}, such that i modulo (N+1)=n.

Once the first partial results of each output neuron have been computed and recorded in the corresponding accumulator, the following input datum X₁^{k} is propagated to all of the input registers Reg_inₙ in order to compute and add the second term of each weighted sum in accordance with the same computing principle.

The same operation is repeated until having computed and added all of the partial results of all of the weighted sums of each output neuron.

This makes it possible to avoid writing the same input datum Xᵢ^{k} to the input registers Reg_inₙ multiple times.

It will be recalled that, if the number of output neurons Nᵢ^{k+1} is greater than the number of computing units, it is necessary to have a plurality of accumulators in each computing unit. The minimum number of accumulators in a computing unit is equal to the number of output neurons Nᵢ^{k+1} denoted M+1 divided by the number of computing units N+1, and more precisely rounded up to the nearest integer of the division result.

The computer CALC associated with the operation described above, configured in accordance with the first configuration CONF1 and with an appropriately determined distribution of the synaptic coefficients wᵢⱼ^{k+1} between the weight memories MEM_POIDSₙ, executes all of the operations of computing a fully connected layer of neurons during propagation of the data or inference.

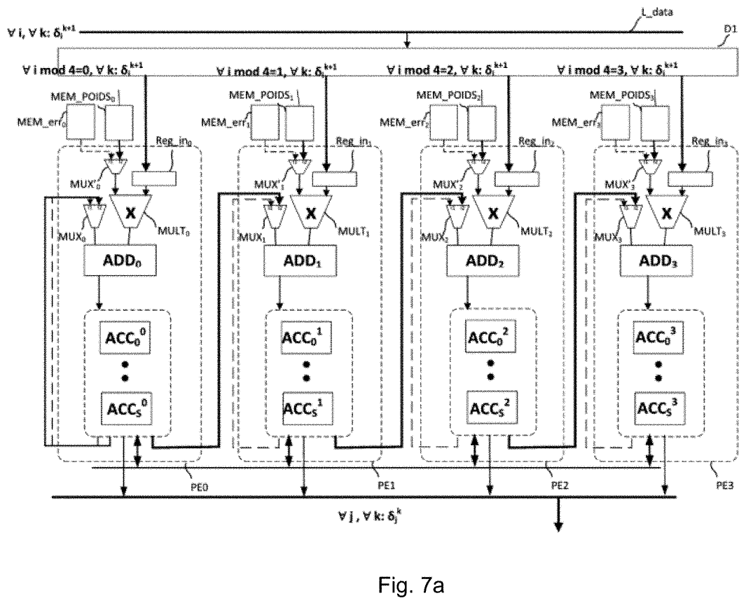

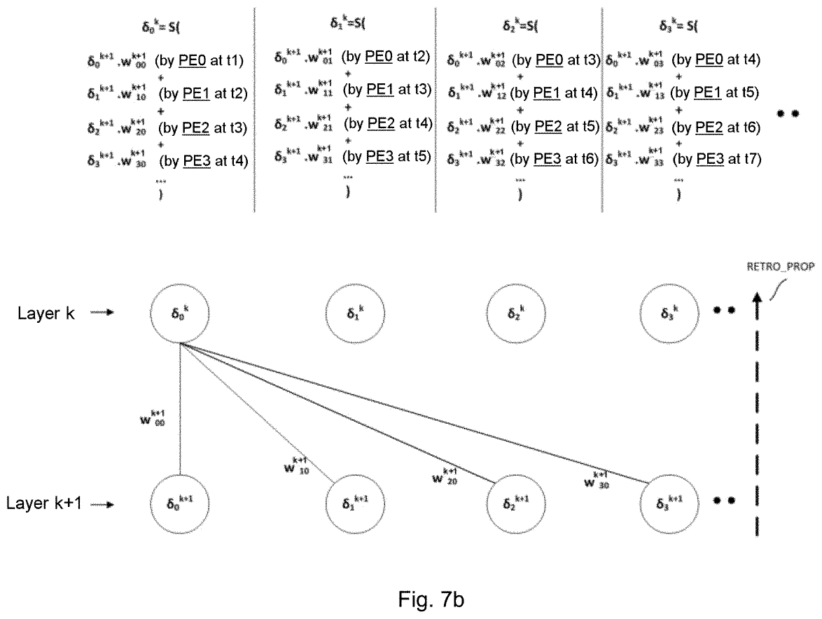

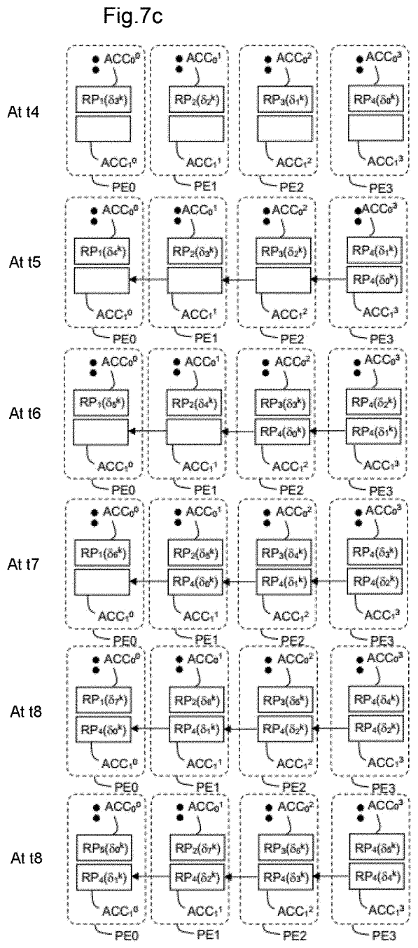

FIG. 7a illustrates a functional diagram of the accelerator computer CALC configured in accordance with the second configuration CONF2 so as to compute a layer of artificial neurons in a back-propagation phase.

In an error back-propagation phase, each multiplexer MUX′ₙ of rank n is configured, by the control means, so as to select the input connected to the associated weight memory.

When the second configuration CONF2 is chosen, the control means configure each multiplexer MUXₙ belonging to the computing unit PEₙ, where n=1 to N, so as to select the second input I2 connected to the output S1ⁿ⁻¹ of the set of accumulators {ACC₀ⁿ⁻¹ ACC₁ⁿ⁻¹ ACC₂ⁿ⁻¹ . . . } of the preceding computing unit PEₙ₋₁ of rank n-1. The adder ADDₙ of each computing unit PEₙ (except for the initial computing unit) thus receives the partial computing results from the preceding computing unit so as to add it to the output from the multiplier circuit MULTₙ. With regard to the initial computing unit PE₀ the adder ADD₀ is still connected to the set of accumulators {ACC₀⁰ ACC₁⁰ ACC₂⁰ . . . } of the same computing unit.

It will be recalled firstly that each weight memory MEM_POIDSₙ of rank n comprises each row vector [Lᵢ]^{k+1}=(wᵢ₀^{k+1}, wᵢ₁^{k+1}, wᵢ₂^{k+1}, wᵢ₃^{k+1} . . . , w_{i(M-2)}^{k+1}, w_{i(M-1)}^{k+1}, w_{iM}^{k+1}) of the matrix [MP]^{k+1} such that i modulo (N+1)=n.

Secondly, the subset of the synaptic coefficients used to compute the weighted sum Σᵢ(δᵢ^{k+1}·wᵢⱼ^{k+1}) in order to obtain the output error δⱼ^{k} of the neuron Nⱼ^{k} corresponds to [Cⱼ]^{k+1} the column vector of the weight matrix [MP]^{k+1} of index j of the weight matrix [MP]^{k+1}, where [Cⱼ]^{k+1}=(w₀ⱼ^{k+1}, w₁ⱼ^{k+1}, w₂ⱼ^{k+1}, w₃ⱼ^{k+1} . . . , w_{(M-2)j}^{k+1}, w_{(M-1)j}^{k+1}, w_{Mj}^{k+1}).

A computing unit PEₙ of rank n thus cannot carry out all of the multiplication operations for computing the weighted sum Σᵢ(δᵢ^{k+1}·wᵢⱼ^{k+1}) on its own. In this case, the execution of the output neuron Nᵢ^{k} computing operations during a back-propagation phase should be shared by all of the computing units, hence the establishment of a series connection between the computing units in order to be able to transfer the partial results through the chain consisting of the computing units PEₙ.

When the second configuration CONF2 is selected, the various sets of accumulators ACCᵢ^{j} form a matrix of interconnected registers for operating in accordance with a “first in first out” (FIFO) principle. Without a loss of generality, this type of implementation is one example for propagating the flow of partial results between the last computing unit and the first computing unit of the chain. A simplified example for explaining the operating principle of the “FIFO” memory in the computer according to the invention will be described below.

In one alternative embodiment, it is possible to implement the operation in accordance with the “first in first out” (FIFO) principle using a FIFO memory stage whose input is connected to the accumulator ACC₀^{N} of the last computing unit PE_{N} and whose output is connected to the input I2 of the multiplexer MUX₀ of the initial computing unit PE₀. In this embodiment, each computing unit PEₙ of rank n comprises only one accumulator ACC₀ⁿ comprising the partial results of the computing of the weighted sum carried out by the same computing unit PEₙ.

FIG. 7b illustrates one example of computing sequences carried out by the computer CALC according to the invention configured in accordance with the second configuration CONF2 in a back-propagation phase as shown in FIG. 7a.

In the 1^{st} computing cycle t1, the computing unit PE₀ multiplies the first error datum δ₀^{(k+1)} by the weight w₀₀^{(k+1)} and transmits the result to the following computing unit PE₁ which, in the second computing cycle t2, adds to it the product of the second datum δ₁^{(k+1)} and the weight w₁₀ and transmits the result to the computing unit PE₂, and so on, in order to compute the output until obtaining the partial sum consisting of the four first terms of the weighted sum of the output δ₀^{(k)} equal to:

δ₀^{(k+1)}·w₀₀^{k+1}+δ₁^{(k+1)}·w₁₀^{k+1}+δ₂^{(k+1)}·w₂₀^{k+1}+δ₀^{(k+1)}·w₂₀^{k+1}

During this same second cycle t2, the computing unit PE0 multiplies the 1^{st} datum δ₀^{(k+1)} still stored in its input register REG_in₀ by the weight w₀₁^{(k+1)} and transmits the result to the following computing unit PE₁ so as to add δ₀^{(k+1)}·w₀₁^{(k+1)} to δ₁^{(k+1)}·w₁₁^{(k+1)} at t3 in order to compute the output δ₁^{(k)}. The same principle is repeated along the chain of computing units, as illustrated in FIG. 7b.

At the end of the fourth cycle t4, the last computing unit of the chain PE₃ therefore obtains a partial result of δ₀^{(k)} on the four first data. The partial result enters the FIFO structure formed by the accumulators of all of the computing units.

The depth of the memory stage operating in FIFO mode should be dimensioned so as to achieve the following operation. By way of example, the first partial result δ₀^{(k)}: δ₀^{(k+1)}·w₀₀^{k+1}+δ₁^{(k+1)}·w₁₀^{k+1}+δ₂^{(k+1)}·w₂₀^{k+1}+δ₃^{(k+1)}·w₃₀^{k+1} should be present in an accumulator of the set of accumulators of the initial computing unit in the corresponding cycle upon the resumption of the computation δ₀^{(k)} by the initial computing unit PE₀.

This then depends on the sequence of the computing operations carried out by the computer CALC during the back-propagation phase. Without a loss of generality, we will describe one possible operation of the set of accumulators for avoiding having to carry out multiple successive read operations on input data in the input registers Reg_inₙ.

In the computing cycle t4, the initial computing unit PE₀ computes the first term of the weighted sum of the error δ₄^{(k)}. After M computing cycles, the initial computing unit PE₀ resumes computing the error δ₀^{(k)} after having computed the partial result consisting of the four first terms for all of the output neurons Nᵢ^{k}. In this case, the depth of the memory stage operating in FIFO mode should be equal to the number of neurons of the layer Cₖ. Each computing unit thus comprises a set of accumulators consisting of S accumulators, such that S is equal to the number of neurons of the output layer Cₖ divided by the number of computing units PEₙ rounded up to the nearest integer.

FIG. 7c illustrates a simplified example for better understanding the operation of the set of accumulators in accordance with the “first input first output” principle when the computer CALC carries out the computations of a back-propagation with the second configuration CONF2.

To explain the routing of the computed partial results through the set of accumulators in accordance with the “first in first out” principle, FIG. 7c illustrates all of the sets of accumulators with the following parameters:

The number of neurons in the input layer Cₖ₊₁ is 8.

The number of neurons in the output layer Cₖ is 8.

The computer CALC contains four computing units PEₙ, where n is from 0 to 3.

Each computing unit PEₙ of rank n contains two accumulators ACC₀ⁿ and ACC₁ⁿ.

Let RPⱼ(δᵢ^{(k)}) be the partial result consisting of the j first terms of the weighted sum corresponding to the output result δᵢ^{(k)}.

The sequence of the computations during the four first cycles t1 to t4 has been described above. At t4, the accumulator ACC₀³ of the last computing unit PE₃ contains the partial result of δ₀^{(k)} containing the four first terms denoted RP₄(δ₀^{(k)}); the accumulator ACC₀² of the computing unit PE₂ contains the partial result of δ₁^{(k)} consisting of the three first terms denoted RP₃(δ₁^{(k)}), the accumulator ACC₀¹ of the computing unit PE₁ contains the partial result of δ₂^{(k)} consisting of the two first terms denoted RP₂(δ₂^{(k)}), and the accumulator ACC₀⁰ of the computing unit PE₀ contains the partial result of δ₃^{(k)} consisting of the first term denoted RP₁(δ₃^{(k)}) The rest of the accumulators {ACC₁⁰ ACC₁¹ ACC₁² ACC₁³} used to implement the FIFO function are empty in this computing step.

At t5, the partial result RP₄(δ₀^{(k)}) is transferred to the second accumulator of the computing unit PE₃, denoted ACC₁³. The partial result RP₄(δ₀^{(k)}) thus enters the row of accumulators {ACC₁⁰ ACC₁¹ ACC₁² ACC₁³} that form the FIFO. At the same time, the initial computing unit PE₀ computes the first product of the error δ₄^{(k)} so as to store, in ACC₀⁰, the partial result of δ₄^{(k)} consisting of the first term, denoted RP₁(δ₄^{(k)}); the computing unit PE₁ computes the second product of the error δ₃^{(k)} so as to store, in ACC₀¹, the partial result of δ₃^{(k)} consisting of the two first terms, denoted RP₂(δ₃^{(k)}). In the same way, ACC₀² contains the partial result RP₃(δ₂^{(k)}) and ACC₀³ contains the partial result RP₄(δ₂^{(k)}).

At t6, the partial result RP₄(δ₀^{(k)}) is transferred to the second accumulator ACC₁² of the preceding computing unit. The partial result RP₄(δ₁^{(k)}) is transferred to the accumulator ACC₁³ and thus enters the group of accumulators that forms the FIFO. The computations through the computing unit chain continue in the same way as described above.

Thus, in each computing cycle, each partial result computed by the last computing unit enters the chain of accumulators {ACC₁⁰ ACC₁¹ ACC₁² ACC₁³} that form the FIFO, and the initial computing unit initiates the computations of the first term of a new output result δᵢ^{(k)}.

The partial result RP₄(δ₀^{(k)}) runs through the FIFO chain, being transferred to one of the accumulators of the preceding computing unit in each computing cycle.

At t8, the partial result RP₄(δ₀^{(k)}) is stored in the last accumulator of the FIFO chain corresponding to ACC₁⁰, while the initial computing unit PE₀ computes the first term of the partial result RP₁(δ₇^{(k)}) stored in the accumulator ACC₀⁰ and corresponding to the last neuron of the computed layer.

At t9, the initial computing unit PE₀ resumes computing the error δ₀^{(k)}. The computing unit PE₀ adds RP₄(δ₀^{(k)}), stored beforehand in the accumulator ACC₁⁰, to the multiplication result at the output of MULT and stores the obtained partial result RP₅(δ₀^{(k)}) in ACC₀⁰. A second cycle of multiplication and summing operations through the computing unit chain PEₙ is started.

The same principle applies to the other partial results of the other errors δᵢ^{(k)}, thereby creating operation in which the partial results run in succession in a defined order through the FIFO memory stage from the last computing unit PE₃ to the initial computing unit PE₀.

This mode of operation may be generalized with a chain of FIFO accumulators comprising multiple rows of accumulators if the ratio between the number of neurons in the computed layer and the number of computing units is greater than 2.

Thus, when the second configuration CONF2 is chosen, each computing unit PEₙ comprises a set of accumulators ACC such that at least one accumulator is intended to store the partial results from the same computing unit PEₙ, and the rest of the accumulators are intended to form the FIFO chain with the adjacent accumulators belonging to the same computing unit or to an adjacent computing unit.

The accumulators used to form the FIFO chain serve to transmit a partial result computed by the last computing unit PE₃ to the first computing unit PE₀ in order to continue computing the weighted sum when the number of neurons is greater than the number of computing units.

The FIFO chain consisting of a plurality of accumulators may be implemented by connecting the accumulators to a 3-state bus, these states connecting the outputs of the associated sets of accumulators to various computing units.

As an alternative, the FIFO chain may also be implemented by converting the accumulator registers to shift registers.

In conclusion, the computer CALC according to the invention makes it possible to compute a fully connected layer of neurons in a propagation phase when the first configuration CONF1 is chosen. The computer additionally computes a fully connected layer of neurons in a back-propagation phase when the second configuration CONF2 is chosen. This mode of operation is compatible with the following distribution of the synaptic coefficients: the subset of synaptic coefficients stored in the weight memory MEM_POIDSₙ of rank n corresponds to the synaptic coefficients w_{i,j}^{k} of all of the rows [Lᵢ] of rank i of the weight matrix [MP]^{k}, such that i modulo (N+1) is equal to n.

As an alternative, by symmetry, the computer CALC may furthermore compute a fully connected layer of neurons in a propagation phase when the second configuration CONF2 is chosen. The computer additionally computes a fully connected layer of neurons in a back-propagation phase when the first configuration CONF1 is chosen. This mode of operation is compatible with the following distribution of the synaptic coefficients: the subset of synaptic coefficients stored in the weight memory MEM_POIDSₙ of rank n corresponds to the synaptic coefficients w_{i,j}^{k} of all of the columns [Cᵢ] of rank i of the weight matrix [MP]^{k}, such that i modulo (N+1) is equal to n.

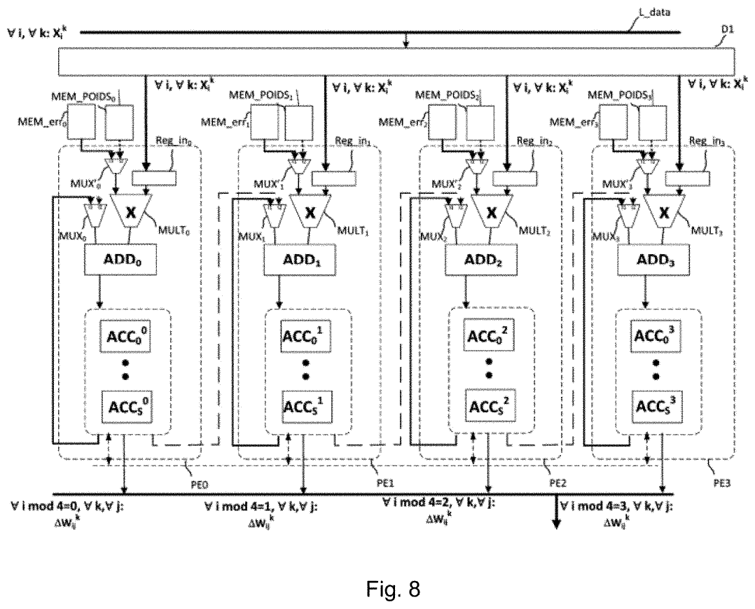

To carry out a learning phase for a neural network, the synaptic coefficients are updated based on the data propagated during a propagation phase and the errors computed for each layer of neurons following back-propagation of errors for a set of image samples used for learning. FIG. 8 illustrates a functional diagram of the accelerator computer CALC configured so as to update the weights during a learning phase.

The multiplexers MUXₙ are configured in accordance with the first configuration CONF1, and what changes is the selection of the input of the multiplier circuits MULTₙ. Specifically, the phase of updating the weights comprises the following computation: ΔWᵢⱼ^{(k)}=1/N_{batch}*Σ_{Nbatch}Xᵢ^{(k)}·δⱼ^{(k)}, where N_{batch} is the number of image samples used for the learning and ΔWᵢⱼ^{(k)} are the weight increments used for the updating.

During the computing of the errors δⱼ^{(k)} of a layer of neurons Cₖ, the output results δⱼ^{(k)} are stored as they are generated in the error memories MEM_errₙ belonging to the various computing units PEₙ. The errors are distributed among the various memories as follows: the error δⱼ^{(k)} of rank j is stored in the error memory MEM_errₙ of rank n, such that j modulo (N+1) is equal to n.

The multiplexers MUX′ₙ are then configured by the control means so as to select the errors δⱼ^{(k)} recorded beforehand in the error memories MEM_errₙ during the back-propagation phase, as the error results are obtained. The stored errors δⱼ^{(k)} are multiplied by the distributed data Xᵢ^{(k)} in a sequence of computing operations chosen by the designer.

The computing architecture proposed by the invention thus makes it possible to carry out all of the computing phases executed by a neural network with one and the same partially reconfigurable architecture.

In the following section, we will explain the application of the accelerator computer CALC for computing a convolutional layer. The operating principle in accordance with the two configurations CONF1 and CONF2 of the computer remains unchanged. However, the distribution of the weights among the various weight memories MEM_POIDSₙ should be adapted so as to carry out the computations that are performed for a convolutional layer.

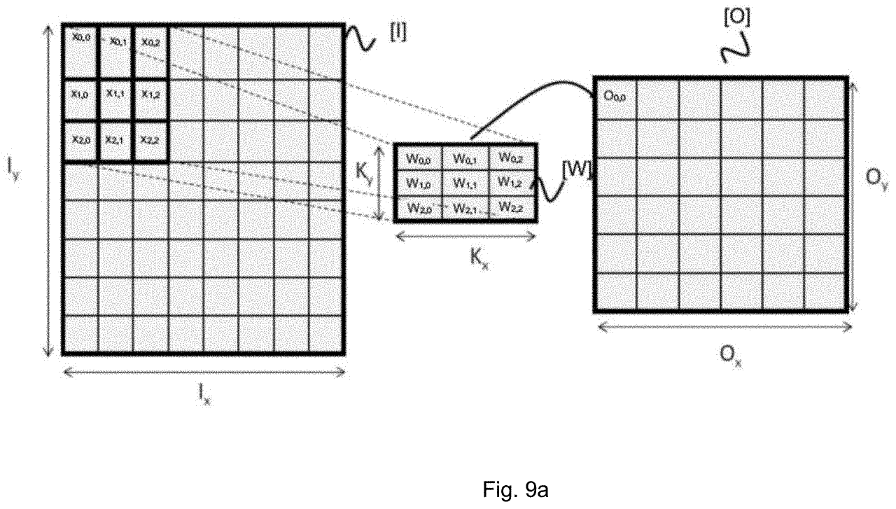

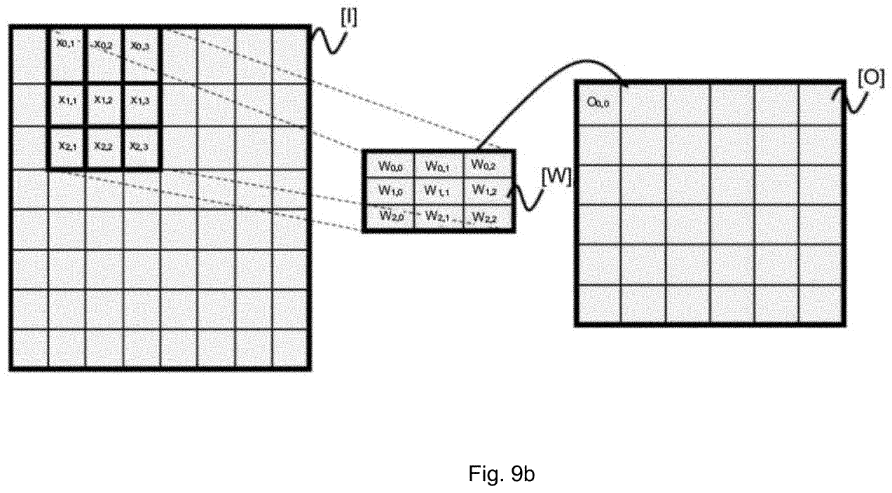

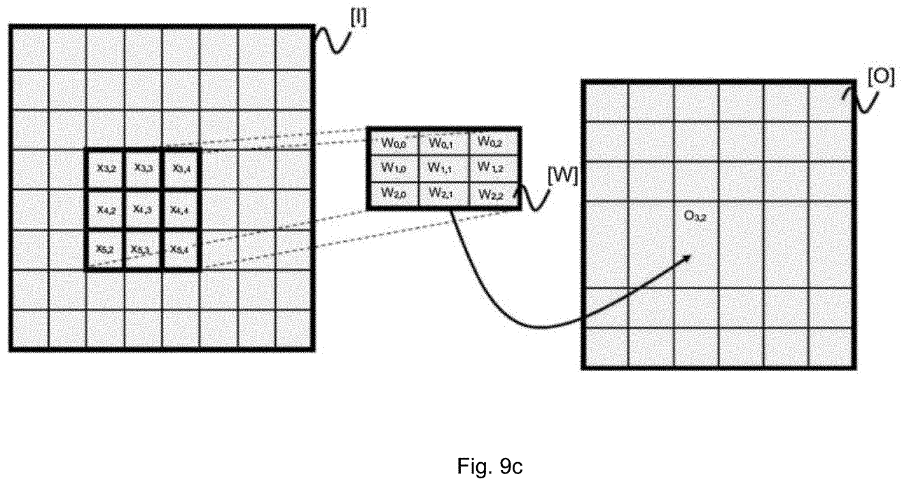

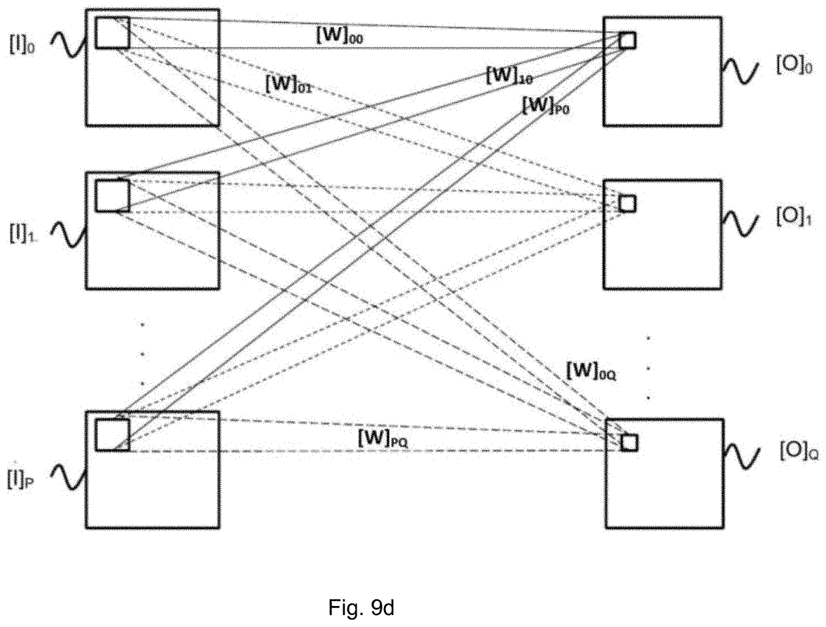

FIGS. 9a-9d illustrate the general operation of a convolutional layer.

FIG. 9a shows an input matrix [I] of size (Iₓ,I_{y}) connected to an output matrix [O] of size (Oₓ,O_{y}) via a convolutional layer carrying out a convolution operation using a filter [W] of size (Kₓ,K_{y}).

A value O_{i,j} of the output matrix [O] (corresponding to the output value of an output neuron) is obtained by applying the filter [W] to the corresponding sub-matrix of the input matrix [I].

FIG. 9a shows the first value O_{0,0} of the output matrix [O] obtained by applying the filter [W] to the first input sub-matrix of dimensions equal to those of the filter [W].

FIG. 9b shows the second value O_{0,1} of the output matrix [O] obtained by applying the filter [W] to the second input sub-matrix.

FIG. 9c shows a general case of computing an arbitrary value O_{3,2} of the output matrix.

Generally speaking, the output matrix [O] is connected to the input matrix [I] by a convolution operation, via a convolution kernel or filter denoted [W]. Each neuron of the output matrix [O] is connected to a portion of the input matrix [I], this portion being called “input sub-matrix” or else “receptive field of the neuron” and having the same dimensions as the filter [W]. The filter [W] is shared by all of the neurons of an output matrix [O].

The values of the output neurons O_{i,j} put into the output matrix [O] are given by the following relationship:

$${O}_{i , j} = g ( {\sum }_{t = 0}^{( {K}_{x} - 1 )} {\sum }_{l = 0}^{( {K}_{y} - 1 )} {x}_{i . {s}_{i} + t , j . {s}_{j} + l \cdot } {w}_{t , l} )$$

In the above formula, g( ) denotes the activation function of the neuron, while sᵢ and sⱼ respectively denote the vertical and horizontal stride parameters. Such a stride corresponds to the offset between each application of the convolution kernel on the input matrix. For example, if the stride is greater than or equal to the size of the kernel, then there is no overlap between each application of the kernel. It will be recalled that this formula is applicable if the input matrix has been processed so as to add additional rows and columns (padding). The filter matrix [W] is formed by the synaptic coefficients w_{t,l} of ranks t=0 to Kₓ−1 and I=0 to K_{y}−1.

More generally, each convolutional layer of neurons, denoted Cₖ, may receive a plurality of input matrices on a plurality of input channels of rank p=0 to P, where P is a positive integer, and/or compute multiple output matrices on a plurality of output channels of rank q=0 to Q, where Q is a positive integer. [W]_{p,q}^{,k+1} denotes the filter corresponding to the convolution kernel that connects the output matrix [O]_{q} of the layer of neurons Cₖ₊₁ to an input matrix [I]ₚ in the layer of neurons Cₖ. Various filters may be associated with various input matrices for the same output matrix.

For simplicity, the activation function go is not shown in FIGS. 9a-9d.

FIGS. 9a-9c illustrate a case in which a single output matrix [O] is connected to a single input matrix [I].

FIG. 9d illustrates another case in which multiple output matrices [O]_{q} are each connected to multiple input matrices [I]p. In this case, each output matrix [O]_{q} of the layer Cₖ is connected to each input matrix Iₚ via a convolution kernel [W]_{p,q,}^{k} that may be different depending on the output matrix.

Moreover, when an output matrix is connected to multiple input matrices, the convolutional layer, in addition to each convolution operation described above, sums the output values of the neurons obtained for each input matrix. In other words, the output value of an output neuron (or also called output channels) is in this case equal to the sum of the output values obtained for each convolution operation applied to each input matrix (or also called input channels).

The values of the output neurons O_{i,j} of the output matrix [O]_{q} are given in this case by the following relationship:

$${O}_{i , j , q} = g ( {\sum }_{p = 0}^{P} {\sum }_{t = 0}^{( {K}_{x} - 1 )} {\sum }_{l = 0}^{( {K}_{y} - 1 )} {x}_{p , i . {s}_{i} + t , j . {s}_{j} + l \cdot } {w}_{p , q , t , l} )$$

Where p=0 to P is the rank of an input matrix [I]p connected to the output matrix [O]_{q} of the layer Cₖ of rank q=0 to Q via the filter [W]_{p,q}^{,k} formed of the synaptic coefficients w_{p,q,t,l} of ranks t=0 to Kₓ−1 and I=0 to K_{y}−1.

Thus, to compute the output result of an output matrix [O]_{q} of rank q of the layer Cₖ, it is necessary to have the set of synaptic coefficients of the weight matrices [W]ₚ,q connecting all of the input matrices [I]p to the output matrix [O]_{q} of rank q.

The computer CALC is thus able to compute a convolutional layer with the same mechanisms and configurations as described for the example of the fully connected layer if the synaptic coefficients are expediently distributed among the weight memories MEM_POIDSₙ.

When the subset of synaptic coefficients stored in the weight memory MEM_POIDSₙ of rank n corresponds to the synaptic coefficients belonging to all of the weight matrices Wₚ,q associated with the output matrix of rank q, such that q modulo (N+1) is equal to n, the computing unit PEₙ carries out all of the multiplication and addition operations for computing the output matrix O_{q} of rank q of the layer Cₖ during propagation of the data or inference. The computer is configured in this case in accordance with the first configuration CONF1 described above.

When the computer is configured in accordance with the second configuration, distributing the synaptic coefficients in accordance with the rank of the associated output channel allows the computer CALC to perform the computations of a back-propagation phase.

Reciprocally, when the subset of synaptic coefficients stored in the weight memory MEM_POIDSₙ of rank n corresponds to the synaptic coefficients belonging to all of the weight matrices W_{p,q,k} associated with the input matrix of rank p (or input channel), such that p modulo (N+1) is equal to n, the computer carries out propagation with the second configuration CONF2 and back-propagation with the first configuration CONF1.

The principle of executing the computations remains the same as that described for a fully connected layer.

The computer CALC according to the embodiments of the invention may be used in many fields of application, notably in applications in which a classification of data is used. The fields of application of the computer CALC according to the embodiments of the invention comprise, for example, video-surveillance applications with real-time recognition of people, interactive classification applications implemented in smartphones for interactive classification applications, data fusion applications in home surveillance systems, etc.

The computer CALC according to the invention may be implemented using hardware and/or software components. The software elements may be present in the form of a computer program product on a computer-readable medium, which medium may be electronic, magnetic, optical or electromagnetic. The hardware elements may be present, in full or in part, notably in the form of dedicated integrated circuits (ASICs) and/or configurable integrated circuits (FPGAs) and/or in the form of neural circuits according to the invention or in the form of a digital signal processor DSP and/or in the form of a graphics processor GPU, and/or in the form of a microcontroller and/or in the form of a general-purpose processor, for example. The computer CALC also comprises one or more memories, which may be registers, shift registers, a RAM memory, a ROM memory or any other type of memory suitable for implementing the invention.

1. A computer (CALC) for computing a layer (Cₖ, Cₖ₊₁) of an artificial neural network, the neural network being formed of a sequence of layers (Cₖ, Cₖ₊₁) each consisting of a set of neurons, each layer being associated with a set of synaptic coefficients (w_{i,j}^{k+1}) forming at least one weight matrix ([MP]^{k+1}, W_{P,Q}), the computer (CALC) being able to be configured in accordance with two separate configurations (CONF1, CONF2) and comprising:
a transmission line (L_data) for distributing input data (Xⱼ^{k}, δᵢ^{k+1}, x_{i,j}),
a set of computing units (PE₀, PE₁, PE₂, PE₃) of ranks n=0 to N, where N is an integer greater than or equal to 1, for computing an input data sum weighted by synaptic coefficients,
a set of weight memories (MEM_POIDS₀, MEM_POIDS₁, MEM_POIDS₂, MEM_POIDS₃) each associated with a computing unit (PE₀, PE₁, PE₂, PE₃), each weight memory containing a subset of synaptic coefficients required and sufficient for the associated computing unit (PE₀, PE₁, PE₂, PE₃) to carry out the computations necessary for either one of the two configurations (CONF1, CONF2),
control means for configuring the computing units (PE₀, PE₁, PE₂, PE₃) of the computer (CALC) in accordance with either one of the two configurations (CONF1, CONF2),
in the first configuration (CONF1), the computing units being configured such that a weighted sum is computed in full by one and the same computing unit,
in the second configuration (CONF2), the computing units being configured such that a weighted sum is computed by a chain of multiple computing units arranged in series.

2. The computer (CALC) according to claim 1, wherein the first configuration and the second configuration correspond, respectively, to operation of the computer in either one of the phases from among a data propagation phase and an error back-propagation phase.

3. The computer (CALC) according to claim 2, wherein the input data (Xⱼ^{k}, δᵢ^{k+1}, x_{i,j}) are data (Xⱼ^{k}, x_{i,j}) propagated in the data propagation phase or errors (δᵢ^{k+1}) back-propagated in the error back-propagation phase.

4. The computer (CALC) according to claim 1, wherein the number of computing units (PE₀, PE₁, PE₂, PE₃) is lower than the number of neurons in a layer (Cₖ, Cₖ₊₁).

5. The computer (CALC) according to claim 1, wherein each computing unit comprises:
i. an input register (Reg_in₀, Reg_in₁, Reg_in₂, Reg_in₃) for storing an input datum (Xⱼ^{k}, δᵢ^{k+1}, x_{i,j});
ii. a multiplier circuit (MULT) for computing the product of an input datum (Xᵢ^{k}, δᵢ^{k+1}, x_{i,j}) and a synaptic coefficient (w_{i,j}^{k});
iii. an adder circuit (ADD₀, ADD₁, ADD₂, ADD₃) having a first input connected to the output of the multiplier circuit (MULT₀, MULT₁, MULT₂, MULT₃) and being configured so as to carry out operations of summing partial computing results of a weighted sum;
iv. at least one accumulator (ACC₀⁰, ACC_{S}⁰, ACC₀¹, ACC_{S}¹, ACC₀², ACC_{S}², ACC₀³, ACC_{S}³) for storing partial or final computing results of the weighted sum.

6. The computer (CALC) according to claim 5, comprising:
a data distribution element (D1) having N+1 outputs, each output being connected to the register (Reg_in₀, Reg_in₁, Reg_in₂, Reg_in₃) of a computing unit of rank n (PE₀, PE₁, PE₂, PE₃),
the distribution element (D1) being commanded by the control means so as to simultaneously distribute an input datum (Xᵢ^{k}, δᵢ^{k+1}, x_{i,j}) to all of the computing units (PE₀, PE₁, PE₂, PE₃) when the first configuration (CONF1) is activated.

7. The computer (CALC) according to claim 5, furthermore comprising a memory stage operating in accordance with a “first in first out” principle so as to propagate a partial result from the last computing unit of rank n=N (PE₃) to the first computing unit (PE₀) of rank n=0, the output of said memory stage being connected to the first computing unit (PE₀), and the memory stage being activated by the control means when the second configuration (CONF2) is activated.

8. The computer (CALC) according to claim 5, wherein each computing unit (PE₀, PE₁, PE₂, PE₃) comprises at least a number of accumulators (ACC₀⁰, ACC_{S}⁰) equal to the number of neurons per layer divided by the number of computing units (PE₀, PE₁, PE₂, PE₃) rounded up to the nearest integer.

9. The computer (CALC) according to claim 8, wherein:
each set of accumulators (ACC₀⁰, ACC_{S}⁰, ACC₀¹, ACC_{S}¹, ACC₀², ACC_{S}², ACC₀³, ACC_{S}³) comprises a write input (E1⁰, E1¹, E1², E1³) able to be selected from among the inputs of each accumulator of the set and a read output (S1⁰, S1¹, S1², S1³) able to be selected from among the outputs of each accumulator of the set;
each computing unit (PE₁, PE₂, PE₃) of rank n=1 to N comprising:
a multiplexer (MUX₁) having a first input (I1) connected to the output (S1¹, S1², S1³) of the set of accumulators (ACC₀¹, ACC_{S}¹, ACC₀², ACC_{S}², ACC₀³, ACC_{S}³) of the computing unit of rank n, a second input (I2) connected to the output (S1⁰, S1¹, S1²) of the set of accumulators (ACC₀⁰, ACC_{S}⁰, ACC₀¹, ACC_{S}¹, ACC₀², ACC_{S}²) of a computing unit of rank n−1 and an output connected to a second input of the adder circuit (ADD₁, ADD₂, ADD₃) of the computing unit of rank n;
the computing unit of rank n=0 (PE₀) comprising:
a multiplexer (MUX₀) having a first input (I1) connected to the output of the set of accumulators (ACC₀⁰, ACC_{S}⁰) of the computing unit of rank n=0, a second input (I2) connected to the output (S1⁰) of the set of accumulators (ACC₀³, ACC_{S}³) of the computing unit of rank n=0 and an output connected to a second input of the adder circuit (ADD₀) of the computing unit of rank n=0;
the control means being configured so as to select the first input (I1) of each multiplexer (MUX₀, MUX₁, MUX₂, MUX₃) when the first configuration (CONF1) is chosen and to select the second input (I2) of each multiplexer (MUX₀, MUX₁, MUX₂, MUX₃) when the second configuration (CONF2) is activated.

10. The computer (CALC) according to claim 8, wherein all of the sets of accumulators (ACC₀⁰, ACC_{S}⁰, ACC₀¹, ACC_{S}¹, ACC₀², ACC_{S}², ACC₀³, ACC_{S}³) are interconnected so as to form a memory stage for propagating a partial result from the last computing unit of rank n=N (PE₃) to the first computing unit (PE₀) of rank n=0, the memory stage operating in accordance with a “first in first out” principle when the second configuration (CONF2) is activated.

11. The computer (CALC) according to claim 1, comprising a set of error memories (MEM_err₀, MEM_err₁, MEM_err₂, MEM_err₃), each one being associated with a computing unit (PE₀, PE₁, PE₂, PE₃), for storing a subset of computed errors (δⱼ^{k}).

12. The computer (CALC) according to claim 11, wherein, for each computing unit (PE₀, PE₁, PE₂, PE₃), the multiplier (MULT) is connected to the error memory associated with the same computing unit (MEM_err₀, MEM_err₁, MEM_err₂, MEM_err₃) so as to compute the product of an input datum (Xᵢ^{k}, x_{i,j}) and a stored error signal (δᵢ^{k+1}) during a phase of updating the weights.

13. The computer (CALC) according to claim 1, comprising a read circuit (LECT) connected to each weight memory (MEM_POIDS₀, MEM_POIDS₁, MEM_POIDS₂, MEM_POIDS₃) for commanding the reading of the synaptic coefficients (w_{i,j}^{k}).

14. The computer (CALC) according to claim 1, wherein a computed layer (Cₖ₊₁) is fully connected to the preceding layer (Cₖ), and the associated synaptic coefficients (w_{i,j}^{k}) form a weight matrix ([MP]^{k}) of size M×M′, where M and M are the respective numbers of neurons in the two layers.

15. The computer (CALC) according to claim 14, wherein the distribution element (D1) is commanded by the control means so as to distribute an input datum (Xᵢ^{k}, δᵢ^{k+1}) associated with a neuron of rank i to a computing unit (PE₀, PE₁, PE₂, PE₃) of rank n, such that i modulo N+1 is equal to n, when the second configuration (CONF2) is activated.

16. The computer (CALC) according to claim 14, wherein, when the first configuration (CONF1) is activated, all of the multiplication and addition operations for computing the weighted sum (Xᵢ^{k+1}, δⱼ^{k}) associated with the neuron of rank i are carried out exclusively by the computing unit (PE₀, PE₁, PE₂, PE₃) of rank n, such that i modulo N+1 is equal to n.

17. The computer (CALC) according to claim 14, wherein, when the second configuration (CONF2) is activated, each computing unit (PE₁, PE₂, PE₃) of rank n=1 to N carries out the operation of multiplying each input datum (Xⱼ^{k}, δᵢ^{k+1}) associated with the neuron of rank j by a synaptic coefficient (w_{i,j}^{k}), such that j modulo N+1 is equal to n, followed by addition of the output from the computing unit (PE₀, PE₁, PE₂, PE₃) of rank n−1, so as to obtain a partial or total result of a weighted sum (Xᵢ^{k+1}, δⱼ^{k}).

18. The computer (CALC) according to claim 14, wherein the subset of synaptic coefficients stored in the weight memory (MEM_POIDS₀, MEM_POIDS₁, MEM_POIDS₂, MEM_POIDS₃) of rank n corresponds to the synaptic coefficients (w_{i,j}^{k}) of all of the rows of rank i of the weight matrix ([MP]^{k}), such that i modulo N+1 is equal to n, when the first configuration (CONF1) is a computing configuration for the data propagation phase and the second configuration (CONF2) is a computing configuration for the error back-propagation phase.

19. The computer (CALC) according to claim 14, wherein the subset of synaptic coefficients stored in the weight memory (MEM_POIDS₀, MEM_POIDS₁, MEM_POIDS₂, MEM_POIDS₃) of rank n corresponds to the synaptic coefficients (w_{i,j}^{k}) of all of the columns of rank j of the weight matrix ([MP]^{k}), such that j modulo N+1 is equal to n, when the first configuration (CONF1) is a computing configuration for the error back-propagation phase and the second configuration (CONF2) is a computing configuration for the data propagation phase.

20. The computer (CALC) according to claim 1, wherein the neural network comprises at least one convolutional layer of neurons, the layer having a plurality of output matrices of rank q=0 to Q, where Q is a positive integer, each output matrix being obtained from at least one input matrix of rank p=0 to P, where P is a positive integer,
for each input matrix of rank p and output matrix of rank q pair, the associated synaptic coefficients (w_{i,j}) forming a weight matrix (W_{P,Q}).

21. The computer (CALC) according to claim 20, wherein, when the first configuration (CONF1) is activated, all of the multiplication and addition operations for computing an output matrix of rank q are carried out exclusively by the computing unit (PE₀, PE₁, PE₂, PE₃) of rank n, such that q modulo N+1 is equal to n.

22. The computer (CALC) according to claim 20, wherein, when the second configuration (CONF2) is activated, each computing unit (PE₁, PE₂, PE₃) of rank n=1 to N carries out the operations of computing the partial results obtained from each input matrix of rank p, such that p modulo N+1 is equal to n, followed by addition of the partial result from the computing unit (PE₀, PE₁, PE₂, PE₃) of rank n−1.

23. The computer (CALC) according to claim 20, wherein the subset of synaptic coefficients stored in the weight memory (MEM_POIDS₀, MEM_POIDS₁, MEM_POIDS₂, MEM_POIDS₃) of rank n corresponds to the synaptic coefficients (w_{i,j,p,q}^{k}) belonging to all of the weight matrices (W_{P,Q}) associated with the output matrix of rank q, such that q modulo N+1 is equal to n, when the first configuration (CONF1) is a computing configuration for the data propagation phase and the second configuration (CONF2) is a computing configuration for the error back-propagation phase.

24. The computer (CALC) according to claim 20, wherein the subset of synaptic coefficients stored in the weight memory (MEM_POIDS₀, MEM_POIDS₁, MEM_POIDS₂, MEM_POIDS₃) of rank n corresponds to the synaptic coefficients (w_{i,j}) belonging to all of the weight matrices (W_{P,Q}) associated with the input matrix of rank p, such that p modulo N+1 is equal to n, when the first configuration (CONF1) is a computing configuration for the error back-propagation phase and the second configuration (CONF2) is a computing configuration for the data propagation phase.
